(19) United States
(12) Patent Application Publication
(10) Pub. No.: US 2006/0063120 A1
(43) Pub. Date: Mar. 23, 2006

(54) Sensor unit device and method for avoiding condensation on a surface

(76) Inventors: Reinhold Barlian, Bad Mergentheim (DE); Alfred Boehm, Viechtach (DE)

Correspondence Address: JACOBSON HOLMAN PLLC, 400 SEVENTH STREET N.W., SUITE 600, WASHINGTON, DC, 20004, US

(21) Appl. No.: 10/520,019

(22) PCT Filed: Jun. 10, 2003
(86) PCT No.: PCT/EP03/06073

§ 371 Date: Aug. 19, 2005

(30) Foreign Application Priority Data
Jul. 2, 2003 (DE) 102 29 628.6

(51) Int. Cl. F27D 19/00

(52) U.S. Cl. 432/36

(57) ABSTRACT

The invention relates to a sensor unit for an apparatus for preventing condensation of a gas, particularly water vapour, on a surface of an object, with a temperature measuring device for measuring an object temperature, with a dew point determination device for determining a dew point temperature of the gas in an atmosphere surrounding the object and with a regulating and control device operatively connected to the temperature measuring device and the dew point determination device and with which an adjusting device for increasing a temperature difference between the object temperature and the dew point temperature is controllable as a function of the data obtained by the temperature measuring device and the dew point determination device in such a way that a lowering of the object temperature to or below the dew point temperature is prevented. The sensor unit is inventively characterized in that the dew point determination device is constructed as a dew point sensor for the direct measurement of the dew point and the temperature measuring device is constructed as a temperature sensor operating in contactless manner. The invention also relates to an apparatus and a method for preventing condensation of a gas, particularly water vapour, on a surface of an object.

The present invention relates to a sensor unit according to the preamble of claim 1 and to a method for preventing condensation of a gas, particularly water vapour, on a surface of an object according to the preamble of claim 12. The invention also relates to an apparatus for preventing condensation of a gas, particularly water vapour, on a surface of an object.

A sensor unit according to the preamble for an apparatus for preventing condensation of a gas, particularly water vapour, on a surface of an object has the following components: a temperature measuring device for measuring an object temperature, a dew point determination device for determining a dew point temperature of the gas in an atmosphere surrounding the object and a regulating and control device which is operatively connected to the temperature measuring device and the dew point determination device and with which it is possible to control an adjusting device for increasing a temperature difference between the object temperature and the dew point temperature as a function of data obtained by the temperature measuring device and the dew point determination device in such a way that a reduction of the object temperature to or below the dew point temperature is avoided.

In a method according to the preamble for preventing condensation of a gas, particularly water vapour, on a surface of an object, the following method steps are performed: (a) measuring an object temperature, (b) determining a dew point temperature of the gas in an atmosphere surrounding the object and (c) raising the object temperature and/or reducing the dew point temperature as a function of the object temperature measured in step (a) and/or the dew point temperature determined in step (b) for avoiding a lowering of the object temperature to or below the dew point temperature.

Such sensor units or such a method can be used in process engineering, as well as in automotive engineering. In the latter it is of greater importance to prevent condensation, particularly of water vapour, on surfaces. For example in vehicle traffic dangerous situations can arise due to the “misting” of the windscreen.

Hitherto such sensor units have been implemented with capacitive humidity or moisture sensors or those based on a conductivity measurement, in conjunction with a contacting temperature sensor. Capacitive humidity sensors determine as the actual measured quantity the “relative humidity”, i.e. a measured quantity which can be determined when knowing the temperature of the partial pressure of water vapour and therefore the dew point temperature of the gas. The basis for this determination is the link between the vapour pressure p_{D} and the drying temperature at a specific relative humidity. All these curves are conventionally plotted in a “hx” graph. In the case of the same vapour pressure p_{D}, i.e. with the same water vapour content x (in g/kg), the measured gas has different “relative humidities” at different drying temperatures.

The dew point temperature, which can be determined from the 100% relative humidity curve is decisive for the “misting” or condensation on a surface.

As the “relative humidity” curves, also referred to as RH curves and the drying temperature as a function of the vapour pressure at a specific relative humidity have a very considerable gradient in the range below 0° C., there is a marked reduction in the sensitivity of the dew point determination in this range.

Capacitive humidity sensors also suffer from the disadvantage of drift, i.e. they are not stable on a long term basis. Such drift more particularly occurs in the case of high and very low humidity levels, which is attributed to saturation or drying effects.

Finally, capacitive humidity sensors are susceptible to dirtying, which is e.g. particularly disadvantageously noticeable if smoking occurs in a passenger compartment of a car.

The object of the invention is to provide a sensor unit and a method of the aforementioned type usable in a variable manner and in which condensation can be reliably prevented. The sensor unit must also be particularly inexpensive to manufacture.

This object is achieved by a sensor unit having the features of claim 1 and a method having the features of claim 12.

Advantageous developments of the sensor unit according to the invention and preferred developments of the method according to the invention form the subject matter of subclaims.

A sensor unit of the aforementioned type is inventively further developed in that the dew point determination device is constructed as a dew point sensor for the direct measurement of the dew point and that the temperature measuring device is constructed as a temperature sensor operating in contactless manner.

Correspondingly a method of the aforementioned type is inventively further developed in that the dew point temperature of the gas is measured directly with a dew point sensor and that the object temperature is measured in contactless manner.

A first basic concept of the present invention is that the dew point temperature is no longer indirectly determined as hitherto by measuring the relative humidity, but instead with the aid of a dew point sensor the dew point temperature is directly measured. As uncertainties when determining the relative humidity no longer play a part for the dew point temperature, condensation on the object surface can be much more reliably prevented.

A second basic concept of the invention relates to the measurement in contactless manner of the object temperature. The inventive sensor unit and inventive method are consequently usable in a particularly variable manner. For example, a moving object can also be monitored and condensation on its surface avoided.

The contactless temperature measurement has the advantage that no energy is removed from the measured object. This is particularly advantageous if the temperature of a surface is to be determined, because in the case of surface temperature measurements frequently the problem arises that the sensor element used removes energy from the surface and this leads to erroneous measurements. In addition, as a result of the contactless temperature measurement it is possible to select a field of measurement through the suitable choice of a difference and an angular aperture, so that e.g. an integral measurement of the surface is also possible. A monitoring of moving objects can in particular be important for industrial manufacturing processes.

The sensor unit according to the invention can be inexpensively manufactured and can be produced by mass production in large numbers at a low price.

A wetting sensor is preferably used as the dew point sensor. This can be a measuring component where the wetting of a measurement surface with the gas in question, i.e. the condensation of said gas, is measured. This leads to the advantage that the state on the object surface where condensation is to be prevented is simulated in the dew point sensor. This particularly reliably prevents condensation on the object surface.

In particularly preferred manner the dew point sensor is constituted by a sensor in which the measuring principle makes use of the change to a light reflection and/or light scattering, particularly an internal reflection, when gas is condensed on a measurement surface.

Such sensors are e.g. known from DE 199 32 438 and in the case of a compact, inexpensive structure have a very low dirtying sensitivity and at the same time an easy cleaning possibility. The optical characteristics of a surface, particularly its reflectivity change very greatly if said surface is wetted with a gas, i.e. if said gas condenses on the surface. This permits a very precise determination of the dew point temperature.

Particular preference is given to a sensor in which the change to an internal reflection due to condensation of the measurement gas on the measurement surface is measured, because this reflection change is largely independent of possible dirtying, such as e.g. by dust, on the measurement surface.

The temperature sensor can be constituted by an infrared sensor and in principle use can be made of any detector suitable for the infrared spectral range, e.g. a photoconductive cell, a thermocouple, a bolometer or a semiconductor detector, such as e.g. a photodiode. However, preferably a thermopile detector is used. Such detectors are obtainable at a low cost and allow a precise temperature measurement.

The precision of the temperature measurement can be further increased if the temperature sensor is provided with a spectral filter. This can in particular be an 8 to 14 μm window, i.e. an atmospheric window.

There can also be a further temperature measuring device for determining the temperature of the atmosphere surrounding the object. This in particular relates to the determination of the temperature in a motor vehicle passenger compartment. With a corresponding regulating device and using the measured interior temperature, assuming a corresponding dew point gap, the climatic conditions in the passenger compartment can be regulated to the comfort range, which leads to considerable advantages for the occupants.

In a particularly preferred development the inventive sensor unit is housed in a common housing. Such a compact structure permits multiple uses and easy replacement of the sensor unit.

The invention also relates to an apparatus for preventing the condensation of a gas, particularly water vapour, on a surface of an object, which has a sensor unit according to the invention, as well as an adjusting device for increasing a temperature difference between the object temperature and the dew point temperature.

With such an apparatus or system the advantages explained in conjunction with the inventive sensor unit are achieved.

The adjusting device can be constructed as a heating device. It can be a device for the direct heating of the object, such as e.g. a rear window heater and/or a device for the indirect heating of the object, such as e.g. a heater blower.

If for particular, e.g. process engineering reasons, a heating of the object is undesired, an increased temperature difference between the object temperature and dew point temperature can be brought about by lowering the dew point temperature. In this case the adjusting device is preferably constructed as a drying device for reducing a gas content, particularly a water vapour content, in the atmosphere surrounding the object.

The apparatus according to the invention can in particular be used for preventing the misting of the windows of a motor vehicle. As a result of the aforementioned, fundamental differences between the sensor unit according to the invention and the prior art and the advantages obtained, with such an apparatus it is possible to particularly reliable prevent condensation of water vapour on windows, i.e. “misting”, and consequently the safety of the occupants is significantly increased.

From the regulation and control standpoint, the control of the adjusting device by the regulating and control device preferably takes place in such a way that the temperature difference between the object temperature and the dew point temperature is kept above a predetermined minimum temperature difference.

Further advantages and characteristics of the sensor unit and method according to the invention are described hereinafter relative to the attached diagrammatic drawings, wherein show:

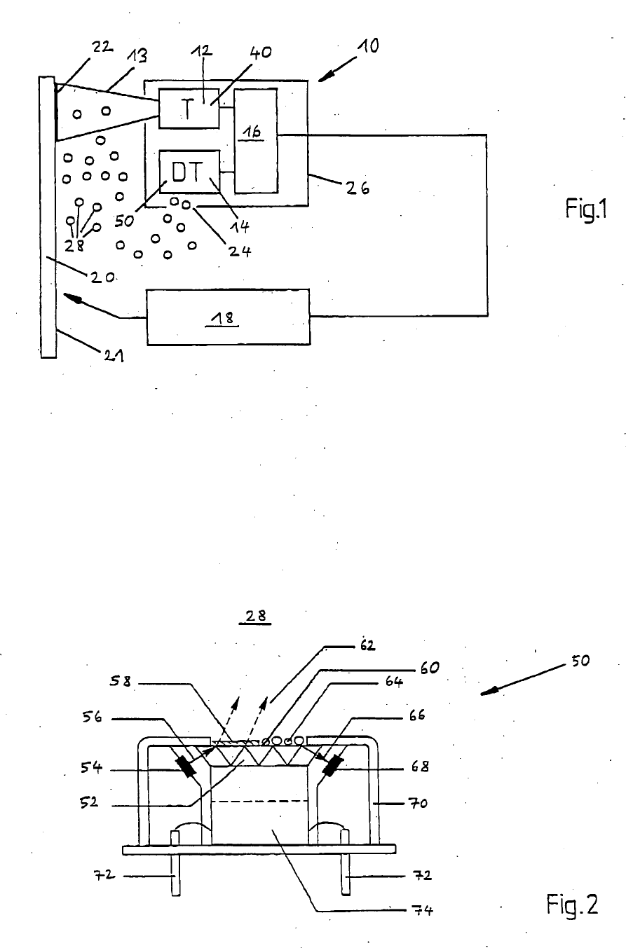

FIG. 1 A diagrammatic view of an inventive apparatus with an inventive sensor unit.

FIG. 2 A diagrammatic view of a dew point sensor such as can be used in the sensor unit according to the invention.

The apparatus shown in FIG. 1 has a sensor unit 10 according to the invention and an adjusting device 18, which can e.g. be a heater blower or a rear window heater. With the aid of a temperature sensor 40 as the temperature measuring device 12, which can be a thermopile sensor, the surface temperature of an object 20 is determined. The temperature sensor 40 establishes in contactless manner the infrared radiation of a measurement spot 22 on the surface 21 of the object 20 and an acceptance range of the temperature sensor 40 is diagrammatically represented by an acceptance cone 13. The temperature sensor 40 is connected to a regulating and control device 16.

The sensor unit 10 also has a dew point sensor 50 as a dew point determining device 14 and this is also connected to the regulating and control device 16. The dew point sensor 50 is used for determining the dew point temperature of a diagrammatically represented gas 28, which can in particular be water vapour and which surrounds the object. The dew point sensor 50 is preferably constructed as a wetting sensor and in particular as a sensor of the type described in DE 199 32 438.

The temperature sensor 40, dew point sensor 50 and regulating and control device 16 are housed in a common housing 26, which ensures a very compact structure. The adjusting device 18, which can e.g. be a heater blower, but also a rear window heater, is controlled by the regulating and control device 16 in such a way that condensation of the gas 28, e.g. water vapour, on the surface 21 of the object 20 is prevented. The measured surface temperature serves as a guide quantity.

If there is a critical temperature difference between the object temperature and the dew point temperature which leads to a condensation risk, corresponding corrective measures must be performed.

The following can be carried out as corrective measures:

a) heating the object 20 (temperature difference between object temperature and dew point temperature increased);

b) “drying” the atmosphere surrounding the object (dew point temperature drops, i.e. the temperature difference between the object temperature and dew point temperature increases);

c) indirect heating of the object by heating the gas (effect as in a)); or

d) a combination of a) to c).

As a result of the determination of the actual (real) dew point temperature it is possible to perform several actions in a targeted manner. In the case of additional knowledge, e.g. of the interior temperature of a passenger compartment, assuming a corresponding temperature difference with respect to the dew point, the climatic conditions can be regulated to the comfort range, which leads to considerable advantages for the occupants.

If a simple anti-misting device is required, it can be advantageous to introduce a ADT control and for this purpose the object temperature is used as the guide quantity. The dew point sensor 50 is regulated to a temperature which is below the object temperature by the ΔDT value (e.g. 5° C.). As soon as misting of the dew point sensor 50 occurs, actions a) to d) are performed. The actions can differ as a function of the object temperature.

FIG. 2 shows a dew point sensor of the type used in preferred manner in the sensor unit according to the invention.

The essential component of this sensor is an arrangement of a light guide 52 into which light 56 is coupled from a transmitter or a source 54, which can e.g. be a light emitting diode. Following a plurality of internal reflections on the outer faces of the light guide 52 coupled out light 66 reaches a receiver 68, which can be a photodiode. A Peltier element 74 is applied to the back of the light guide 52 enabling the latter to be cooled in a defined manner.

During the measurement the Peltier element 74 cools the light guide 52 until a gas 28 to be tested, which can in particular be water vapour, condenses on an outer surface 60 of the light guide 52. Such a condensation coating 58 is diagrammatically illustrated in the left-hand area of surface 60 of light guide 52. Through the wetting of the surface 60, e. with water, there is a rise in the critical angle for the internal reflection above the incidence angle of the light 56 with respect to the surface normal of the surface 60, so that unlike the situation as hitherto, the light is no longer totally reflected on the inner interface and is instead coupled out of the light guide 52. As a result of this fraction of coupled out light 62, the intensity detected in the receiver 68 drops and consequently it can be concluded that there is wetting of the surface 60 and that the dew point temperature has been reached.

The sensor 50 shown in FIG. 2 has as a particular advantage that dirt particles 64 virtually lead to no deterioration of the measurement precision, because if said dirt particles are dry, due to their negligible contact face with the surface 60 of light guide 62 compared with the total area, they only bring about a change to the critical angle for the total reflection in a negligible area percentage.

The overall dew point sensor 50 is compactly housed in a transistor housing 70, on whose underside are provided terminals 72 for controlling the transmitter 54, Peltier element 74 and for reading out a signal of receiver 68.

The dew point sensor 50 shown is characterized by a very small, compact construction, which is designed for mass production, as well as by recyclability. Due to the measuring principle used of a reflection change during condensation on a measurement surface, it constitutes a primary method, where there is no calculating back to the quantity to be determined, here the dew point temperature, so that a high precision can be achieved. Ageing phenomena are minimal with such a sensor, e.g. when compared with capacitive sensors. The sensor also actively simulates what would take place on the window at a corresponding temperature, i.e. possibly misting.

As a result of the measuring principle used the dew point sensor 50 has a very good long term stability, so that recalibrations are unnecessary. A low-maintenance and more maintenance-friendly operation is obtained as a result of the aforementioned significant insensitivity to dirtying and also by the ease of cleaning the sensor. These advantageous characteristics of the dew point sensor 50 consequently permit measurements, particularly also in situ measurements in dust, granules, such as e.g. cereals, etc.

The sensor can be used between −40 and +100° C. When using light guides in place of the transceiver, the temperature range can be further increased and in this case the Peltier element is a limiting factor.

This also defines the humidity or moisture use range. As the sensor principle is based on saturation, it is always adapted to 100% RH.

Possible uses of the sensor unit and method according to the invention are, in addition to process, air conditioning, medical and food engineering, in particular automotive engineering, as has been described hereinbefore. There are also uses in the aeronautical and astronautical industries, as well as in the quality control field.

1. Sensor unit for an apparatus for preventing the condensation of a gas, particularly water vapour, on a surface of an object,
with a temperature measuring device (12) for measuring an object temperature,
with a dew point determination device (14) for determining a dew point temperature of the gas in an atmosphere surrounding the object (20) and
with a regulating and control device (16) operatively connected to the temperature measuring device (12) and the dew point determination device (14) and with which an adjusting device (18) for increasing a temperature difference between the object temperature and the dew point temperature can be controlled as a function of the data obtained by the temperature measuring device (12) and the dew point determination device (14) in such a way that a reduction of the object temperature to or below the dew point temperature is prevented,
characterized in that
the dew point determination device (14) is constructed as a dew point sensor (50) for the direct measurement of the dew point and
the temperature measuring device (12) is constructed as a temperature sensor operating in contactless manner.

2. Sensor unit according to claim 1, characterized in that the temperature sensor is constructed as an infrared sensor.

3. Sensor unit according to claim 2, characterized in that the temperature sensor is a thermopile sensor.

4. Sensor unit according to claim 2, characterized in that the temperature sensor is provided with a spectral filter.

5. Sensor unit according to claim 1, characterized in that the dew point sensor (50) is of the type in which the measuring principle is the change to a light reflection and/or light scattering, particularly an internal reflection, when the gas is condensed on a measurement surface (52).

6. Sensor unit according to claim 1, characterized in that there is a further temperature measuring device for determining the temperature of the atmosphere (28) surrounding the object (20), particularly the temperature within a motor vehicle passenger compartment.

7. Sensor unit according to claim 1 housed in a common housing (26).

8. Apparatus for preventing the condensation of a gas, particularly water vapour, on a surface of an object, having a sensor unit (10) according to claim 1, and with an adjusting device (18) for increasing a temperature difference between the object temperature and dew point temperature.

9. Apparatus according to claim 8, characterized in that the adjusting device is constructed as a heating device for the direct and/or indirect heating of the object.

10. Apparatus according to claim 8, characterized in that the adjusting device is constructed as a drying device for reducing a gas content, particularly a water vapour content, in the atmosphere surrounding the object.

11. Apparatus according to claim 8, characterized in that it is constructed as a means for preventing the misting of the windows of a motor vehicle.

12. Method for avoiding the condensation of a gas, particularly water vapour, on a surface of an object, with the method steps of:
(a) measuring an object temperature,
(b) determining a dew point temperature of the gas in an atmosphere surrounding the object,
(c) raising the object temperature and/or reducing the dew point temperature as a function of the object temperature measured in step (a) and/or the dew point temperature determined in step (b) for preventing a lowering of the object temperature to or below the dew point temperature,
characterized in that
the dew point temperature of the gas is directly measured with a dew point sensor and
the object temperature is measured in contactless manner.

13. Method according to claim 12, characterized in that the temperature difference between the object temperature and dew point temperature is kept above a predetermined minimum temperature difference by a regulating and control device (16).
